(19) United States
(12) Patent Application Publication
(10) Pub. No.: US 2007/0012164 A1
(43) Pub. Date: Jan. 18, 2007

(54) BROWSER-BASED MUSIC RENDERING METHODS

(76) Inventors: Curtis J. Morley, Orem, UT (US); Joshua Brandon Buhler, Riverton, UT (US); Robert Ian Penner, Kelowna (CA); Emerson Tyler Wright, Orem, UT (US)

Correspondence Address: UTAH VALLEY PATENT SERVICES, LLC, 846 S. 1350 E., PROVO, UT, 84606, US

(21) Appl. No.: 11/457,869

(22) Filed: Jul. 17, 2006

Related U.S. Application Data
(60) Provisional application No. 60/700,071, filed on Jul. 18, 2005.

(51) Int. Cl. G10H 7/00; A63H 5/00; G04B 13/00

(52) U.S. Cl. 84/609

(57) ABSTRACT

Blocks of music and related annotations referred to herein as atomic music segments are visually and sonically rendered within a browser window as directed by a set of interface controls thus providing the ability to directly control various performance parameters while also communicating the intentions of the composer, arranger, and engraver in a manner similar to traditional sheet music. Each atomic music segment may include one or more musical elements that have a substantially common onset time thus providing an essentially indivisible unit of music convenient for user interaction and control. In one embodiment, visual formatting provided by an engraver is maintained via a conversion process from a music XML score or the like. The note spacing provided by the engraver may be scaled in response to a transposition request and key signature change, or similar operation, thus providing sheet music of high visual quality and superior interactivity.

### RELATED APPLICATIONS

This application claims priority to U.S. Provisional Patent Application No. 60/700,071 entitled “BROWSER-BASED MUSIC RENDERING METHODS” and filed on 18 Jul. 2005 for Curtis J. Morley, Joshua Brandon Buhler, Robert Ian Penner, and Emerson Tyler Wright, which is incorporated herein by reference.

### BACKGROUND OF THE INVENTION

1. Field of the Invention

The present invention relates generally to systems and methods for distributing and viewing sheet music and more particularly relates to apparatus methods and systems for browser-based visual and sonic rendering of sheet music.

2. Description of the Related Art

FIG. 1 is an illustration of one example of a prior art published musical selection 100. As depicted, the published musical selection 100 includes a variety of elements and markings that communicate the intended expression of the music printed thereon. The published musical selection 100 enables individuals and groups such as musicians, singers, hobbyist, and churchgoers to practice and perform music composed and arranged by others.

A title 110 identifies the name of the selection being performed. A tempo indicator 112 indicates the intended tempo or speed of performance. A key signature 114 specifies the key in which the music is written. A time signature 118 denotes the unit of counting and the number of counts or beats in each measure 120. The depicted measures 120 are separated by bar lines 122.

A system 130 typically contains one or more staffs 132 composed of staff lines 134 that provide a frame of reference for reading notes 136. The notes 136 positioned on the staff lines 134 indicate the intended pitch and timing associated with a voice or part 140.

The published musical selection 100 may include lyrics 150 consisting of verses 160. Within each verse 160, words 162 and syllables 164 are preferably aligned with the notes 136 in order to suggest the phonetic articulations that are to be sung with each note 136.

The elements associated with the published musical selection 100 are the result of hundreds of years of refinement and provide means for composers and arrangers to communicate their intentions for performing the musical selection. The process of formatting published music by an engraver is typically a very tedious and time consuming process that requires a great deal of precision. Furthermore, adding or changing an instrument or transposing the selection to a new key requires the musical selection to be completely reformatted. Additionally, to be effective the published musical selection 100 typically requires either an accompanist who can play the music, or performers who can sight read the music. In many circumstances, such individuals are in limited supply.

In contrast to the published musical selection 100, a media player 200 provides an alternate means of distributing music. As depicted, the media player 200 includes a play button 210, a stop button 220, a pause button 230, a next track button 240, and a previous track button 250. The media player 200 provides a variety of elements that provide a user with direct control over a musical performance without requiring musical literacy or skill. However, the level of control provided by the media player 200 is quite limited and is typically not useful for practicing and performing music.

What is needed are systems, apparatus, and methods that provide users additional control over a musical performance while also communicating the intentions of the composer and arranger of the music, while preserving the refined layout provided by an engraver. Preferably, such methods and systems would work within a standard browser and facilitate the distribution, evaluation, practice, and performance of music for individuals and groups with a wide range of musical skill and literacy.

### SUMMARY OF THE INVENTION

The present invention has been developed in response to the present state of the art, and in particular, in response to the problems and needs in the art that have not yet been fully solved by currently available music publishing means and methods. Accordingly, the present invention has been developed to provide an apparatus, system, and method for rendering music that overcomes many or all of the above-discussed shortcomings in the art.

The present invention provides control over performance parameters such as dynamic voice selection and volume control within a standard browser window. The present invention overcomes the performance limitations typically associated with rendering music within a standard browser window through various techniques including formatting music data into units convenient for visual and sonic rendering. Referred to herein as atomic music segments or blocks, each note and/or annotation within an atomic music segment has a substantially common onset time enabling graphical and sonic rendering of the segment or block as a single functional unit.

The use of atomic music segments, and formatting and rendering techniques associated therewith, enables the present invention to efficiently update a visual representation of sheet music within a standard browser in response to various changes such as transposing a key, disabling a voice, changing an instrument, hiding lyrics, or other user requested preferences or rendering options.

Furthermore, the ability to import sheet music engraved by a professional and convert the notes and annotations into convenient rendering units while maintaining the visual fidelity of actual sheet music within a standard browser window provides quality and flexibility not found in prior art solutions.

In certain embodiments, the internal representation of an atomic music segment has one or more notes with a substantially common onset time and includes a duration indicator that indicates the duration until the next segment (i.e. note onset) within the song. Thus, each atomic music segment is essentially an indivisible unit of music convenient for user interaction and control. In one embodiment, each duration indicator is quantized to a shortest inter-note interval of the song thus reducing the amount of data required to represent a song.

The structure used by the present invention to represent atomic music segments facilitates efficient and coordinated visual and sonic rendering of digital sheet music. The atomic music segments may include other data elements that facilitate an accurate visual rendering of the sheet music such as system indicators, measure indicators, and annotations. A user is provided with direct control over various performance aspects while the intentions of the composer, arranger, and engraver are communicated in manner that is consistent with traditional sheet music. In certain embodiments, a visual rendering of the sheet music is accomplished by rendering the song as a sequence of music systems and measures comprising one or more staffs.

In another aspect of the present invention, the structure used by the present invention to represent atomic music segments provides an efficient mechanism for distributing music, and includes receiving a music description file from a publisher, converting the music description file to a binary image suitable for use in a browser scripting environment, storing the binary data structure on a server, and streaming the binary image to a browser executing on a client. In one embodiment, the binary image comprises a plurality of atomic music segments that enable efficient visual and sonic rendering. In addition, conversion of the music description file to the binary image, compresses the music and reduces the load time and rendering delays on the browser.

In another aspect of the present invention, an apparatus and system for rendering music includes, in one embodiment, a visual rendering module configured to display a song as a sequence of user-selectable atomic music segments, and a sonic rendering module configured to play the song in response to a user-initiated event.

In one embodiment, the visual rendering module includes a system builder that builds a music system, a measure builder that builds a measure, and a segment builder that builds each atomic music segment, a spacing adjuster that adjusts the spacing of segments and staffs to prevent collisions with lyrics, a note renderer that renders basic note shapes, and a detail render that renders slur, ties, annotations, markings, and the like.

The sonic rendering module may be configured with a song loader that receives and loads a song for playback and a sound font loader that receives and loads a note pallete or sound font to facilitate dynamic synthesis of notes and chords. The song loader may preserve the physical layout of sheet music provided by an engraver while converting the song to an internal format suitable for sonic rendering as well as visual reformatting due to a change in key or selective inclusion or exclusion of a part. Furthermore, the sonic rendering module may also include a playback module that facilitates coordinated visual and sonic rendering of the acoustic music segments that comprise the song, and a transpose module that facilitates transposing a song to a different key.

In addition to the visual and sonic rendering modules, the apparatus and system for rendering music within a browser window may also include as set of interface controls and associated event handlers that enable a user to control the rendering process. In one embodiment, the interface controls include controls that enable a user to control the playback tempo, mute or unmute specific voices, change the volume of each voice, specify a particular instrument, activate or inactivate autoscrolling of the sheet music during playback, include or omit the lyrics of a song, and search the lyrics, titles, and topics of a particular song or library of songs.

The aforementioned elements and features may be combined into a system for rendering music within a browser window. In one embodiment, the system includes a server configured to provide digitally encoded music, a browser-equipped client configured to execute a script, and a browser script configured to display a song as a sequence of user-selectable atomic music segments, and play the song in response to a user-initiated event. In certain embodiments, the browser script is further configured to sequentially highlight the atomic music segments in response to a change in a playback position.

In another aspect of the present invention, a method for rendering music within a browser window includes receiving a song from a server, the song comprising a plurality of voices, displaying the song within a browser window, reformatting the song in response to a user inactivating a selected voice of the plurality of voices or requesting transposition of the song to a new key. The described method facilitates loading a song with a large number of voices such as an orchestral score and viewing only those voices that are of interest such as voices corresponding to a specific instrument.

The present invention provides benefits and advantages over currently available music rendering solutions. It should be noted that references throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an illustration of one example of a prior art published music;

FIG. 2 is a screen shot of one embodiment of a prior art media player;

FIG. 3 is a schematic block diagram depicting one embodiment of a music publishing system of the present invention;

FIG. 4 is a block diagram depicting one embodiment of a music publishing apparatus of the present invention;

FIG. 5 is a flow chart diagram depicting certain aspects of one embodiment of a visual rendering method of the present invention;

FIG. 6 is a flow chart diagram depicting certain aspects of one embodiment of a sonic rendering method of the present invention;

FIGS. 7 and 8 are flow chart diagrams depicting certain aspects of one embodiment of a score conversion method of the present invention;

FIG. 9 is a flow chart diagram depicting one embodiment of a copy management method of the present invention;

FIG. 10 is a text diagram depicting one embodiment of an internal data format of the present invention;

FIG. 11 is a partial front view illustration of a page display interface of the present invention;

FIG. 12 is a flow chart diagram depicting one embodiment of a music publication method of the present invention;

FIG. 13 is a flow chart diagram depicting one embodiment of a segment spacing method of the present invention; and

FIG. 14 is an illustration depicting one embodiment of a segment spacing method of the present invention.

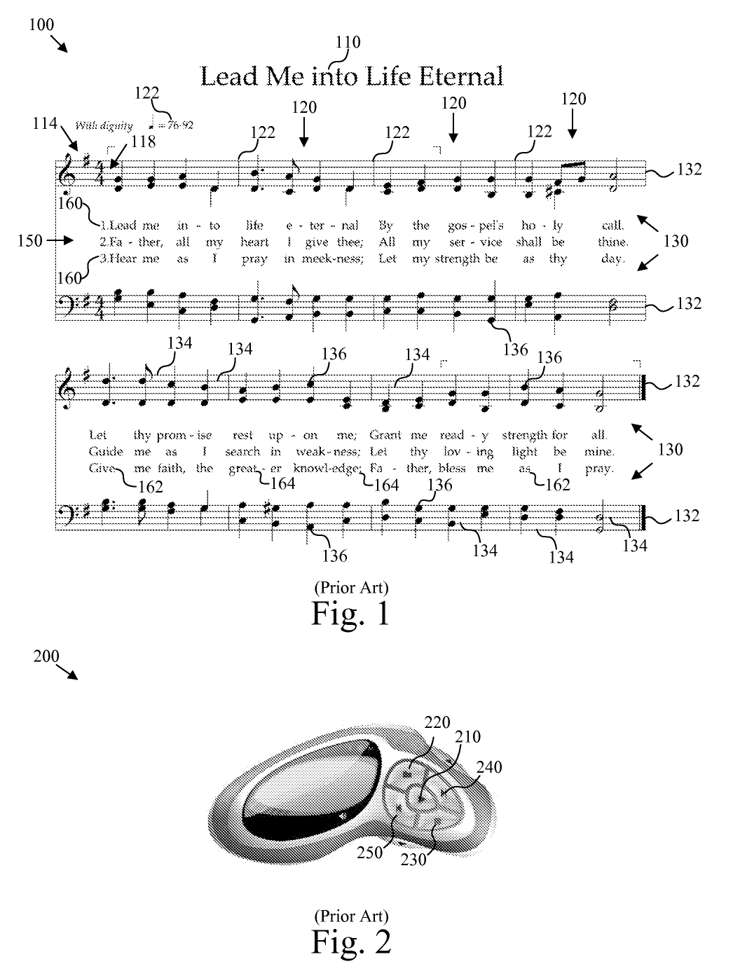

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

The present invention provides a browser-based apparatus method and system for visual and sonic rendering of sheet music that provides functionality beyond the capabilities of the prior art sheet music and prior art digital media players described in the background section. Specifically, the present invention segments song data into atomic music segments (or blocks) and uses the atomic music segments as a fundamental unit for rendering music. Preferably, each note within an atomic music segment has a substantially common onset time thus forming an essentially indivisible unit of music convenient for rendering as well as user interaction and control.

The present invention overcomes the performance and quality limitations typically associated with rendering music within a standard browser window. Specifically, the use of atomic music segments enables the present invention to provide real-time control over performance parameters such as voice selection and volume control while operating within a standard browser window and maintaining the proportional spacing provided by an engraver.

Furthermore, the use of atomic music segments and formatting techniques associated therewith enables the present invention to efficiently update a visual representation of sheet music in response to various changes such as transposing a key, disabling a voice, changing an instrument, hiding lyrics, or other user requested preferences or rendering options.

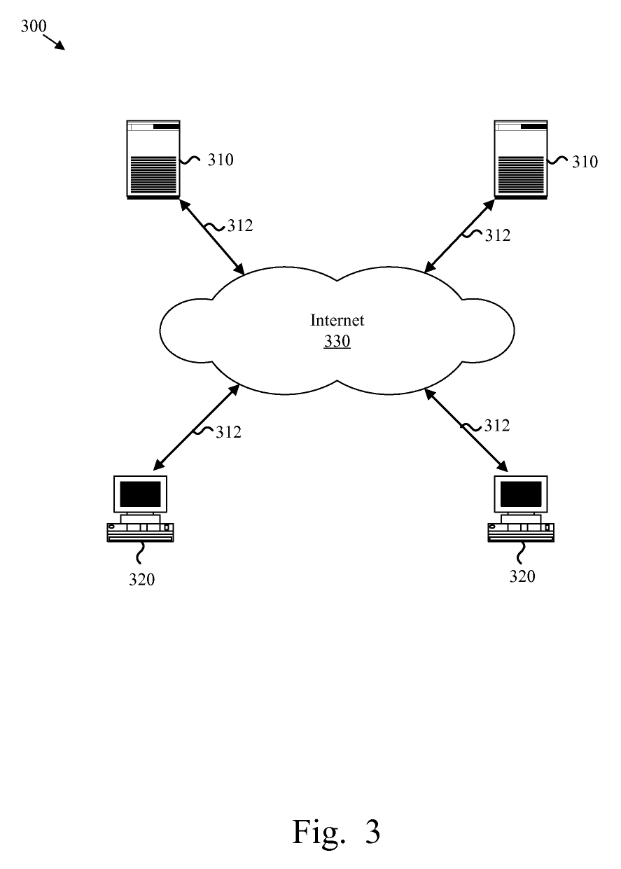

FIG. 3 is a schematic block diagram depicting one embodiment of a music publishing system 300 of the present invention. As depicted, the music publishing system 300 includes one or more atomic music servers 310, one or more atomic music clients 320, and an internet 330. The music publishing system 300 facilitates distribution and perusal of electronic sheet music to users of the internet 330 via a conventional browser.

The atomic music servers 310 provide digitally encoded songs 312 to the atomic music clients 320. The digitally encoded songs 312 may conform to a standard format such as music XML or may be encoded as a sequence of atomic music segments each segment thereof having one or more notes with a substantially common onset time.

In addition to the digitally encoded songs 312, the atomic music servers 310 may provide one or more music conversion and rendering modules (not shown) to the browser-equipped clients 320. In one embodiment, the music conversion and rendering modules are provided as a securely encoded Macromedia Flash™ script (i.e. a .swf file).

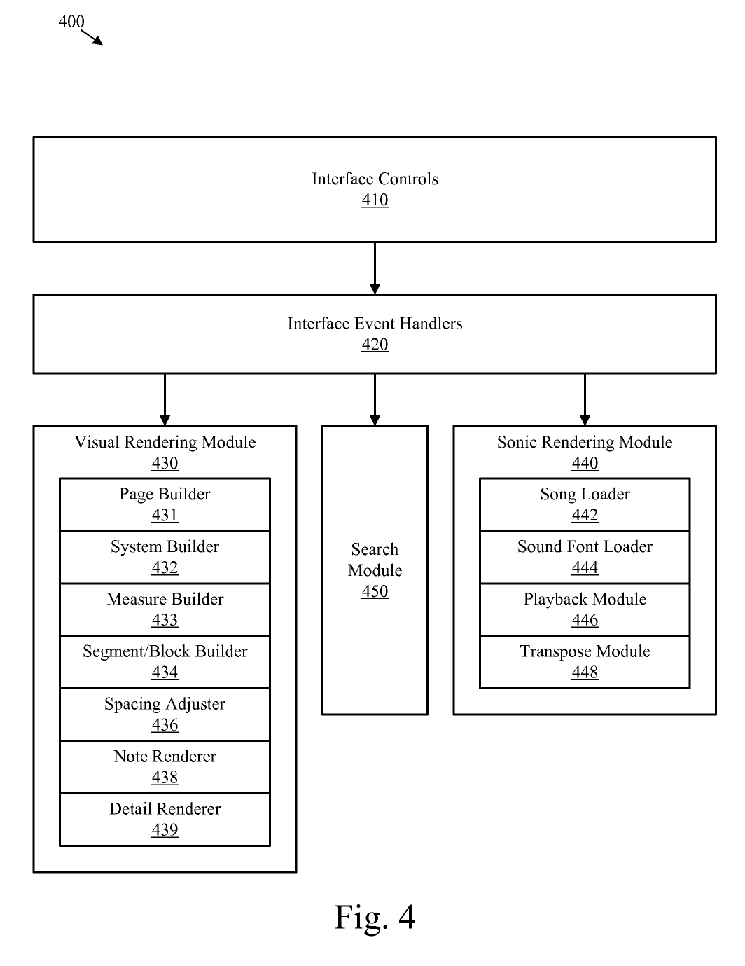

FIG. 4 is a block diagram depicting one embodiment of a music publishing apparatus 400 of the present invention. As depicted, the music publishing apparatus 400 includes a set of interface controls 410, one or more interface event handler(s) 420, a visual rendering module 430, a sonic rendering module 440, and a search module 450. In one embodiment, the music publishing apparatus 410 is achieved via one or more scripts provided by a server and executed by a browser.

The interface controls 410 enable a user to control rendering options, and the like, associated with the apparatus 400. In one embodiment, the interface controls 410 enable a user to control volume, tempo, muting of voices, and other audio-related options. The interface controls 410 may also provide control over the visual display of a song. For example, in one embodiment the interface controls 410 enable a user to display music with or without lyrics, autoscroll to a next line of music, and print a song.

In the depicted embodiment, the interface event handlers 420 respond to changes in the interface controls 410 in order to effect the requested changes. For example, if a user mutes a particular voice an interface event handler 420 may inform the sonic rendering module 440 that the particular voice has been muted. An interface event handler 420 may also change one or more variables corresponding to the requested changes or invoke specific procedures to effect the change. For example, in response to a user disabling lyrics via an interface control, an interface event handler may change a lyric display variable and invoke a page redraw function that accesses the lyric display variable.

The visual rendering module 430 displays a song within a browser window. In the depicted embodiment, specific elements of the song are rendered by the various sub-modules which include a page builder 431, a system builder 432, a measure builder 433, a segment builder 434, a spacing adjuster 436, a note renderer 438, and a detail renderer 439. The song may be rendered within the same window as the interface controls 410 or with a separate window.

The page builder 431 builds a page comprising one or more lines of music or systems. The system builder 432 builds a system comprising one or more staffs. In one embodiment, the system builder 432 computes an initial estimate of the space needed by the system and allocates a display region within the brower window for building the system. The system builder may draw the staffs within the allocated display region upon which notes corresponding to one or more voices will be rendered. In addition, the system builder may draw staff markings and allocate space for measure indicators and the like.

The measure builder 433 may draw the measure indicators and allocate space within the measure for particular segments or blocks. The segment builder 434 builds individual music segments within a system. The segments may be atomic segments or blocks having one or more musical elements with a substantially common onset time (i.e. horizontal position in the score) such as notes, annotations, and lyrics. Under such an arrangement, the onset (or horizontal position) of all the elements of the segment may be common and treated as an atomic unit for both visual and sonic rendering.

In one embodiment, the initial location of the systems, measures, and blocks or segments including both note elements and annotation elements is extracted from a music XML file exported from a musical arrangement or composition program. Thus the initial placement of musical elements may be determined by a professional engraver or the like.

The spacing adjuster 436 may adjust the initial spacing in response to user intiated event such as a transposition request. For example, the width of particular segments may be increased by the spacer adjuster 436 in order to accommodate a larger key signature and the width of other segments may be decreased to accommodate those segments whose widths are increased. In addition to adjusting the (horizontal) width of segments, the spacing adjuster 436 may also adjust the vertical space between staffs to prevent collisions between notes and lyrics.

The note renderer 438 renders the note heads of each segment or block within the system being rendered. The detail renderer 439 renders the note beams and stems as well as additional details such as slurs, ties, and annotations that result in a highly polished visual rendering of each system in the song.

The sonic rendering module 440 plays the visually rendered song in response to a user-initated event such as depressing a play control (not shown). In the depicted embodiment, playing the visually rendered song is accomplished via a number of sub-modules including a song loader 442, an optional sound font loader 444, a playback module 446, and a transpose module 448. The various modules of the sonic rendering module 440 facilitate coordinated visual and sonic rendering of music such as sequentially highlighting music segments synchronous to playback (i.e. sonic rendering) of the segments.

The song loader 442 loads a song within a locally accessible location. In one embodiment, the song loader 442 retrieves a digitally encoded song 312 from a server 310 as described in the description of FIG. 3. The song loader 442 may convert a track-based song encoding such as music XML to a segment-based song encoding preferable for use with the present invention.

The optional sound font loader 444 may load a sound font associated with a song or a sound font selected by a user. In certain embodiments, the sound font is a set of digital audio segments that correspond to notes. In one embodiment, the sound font is restricted to those notes that are referenced in the song.

The playback module 446 plays the loaded song in response to a user-initiated event or the like. Playback is preferably synchronized with visual rendering such as a location bar scrolling through each music block as it is played. Synchronized playback may be accomplished via a timing class built into the block-oriented player. For example, the timing class may activate the notes within a music block and periodically invoke a location bar update function within the visual rendering module to update the position of the location bar within the current music block or segment.

The transpose module 448 transposes the notes within a song in response to a user request or the like. In certain embodiments, the transpose module 448 shifts each note within each music block up or down a selected number of half-steps and invokes a redraw function to update the visual rendering of the song. Updating the visual rendering of the song may include adjusting the vertical spacing between staffs to account for the vertical shifting of notes. Updating may also include horizontal respacing of a system for various factors such as a change in the available system space due to a key signature change.

The search module 450 enables a user to search one or more songs for specific words or topics. In one embodiment, a search may be conducted on the lyrics of the currently loaded song, or the titles, topics, or lyrics of songs within a library of songs stored on a selected server.

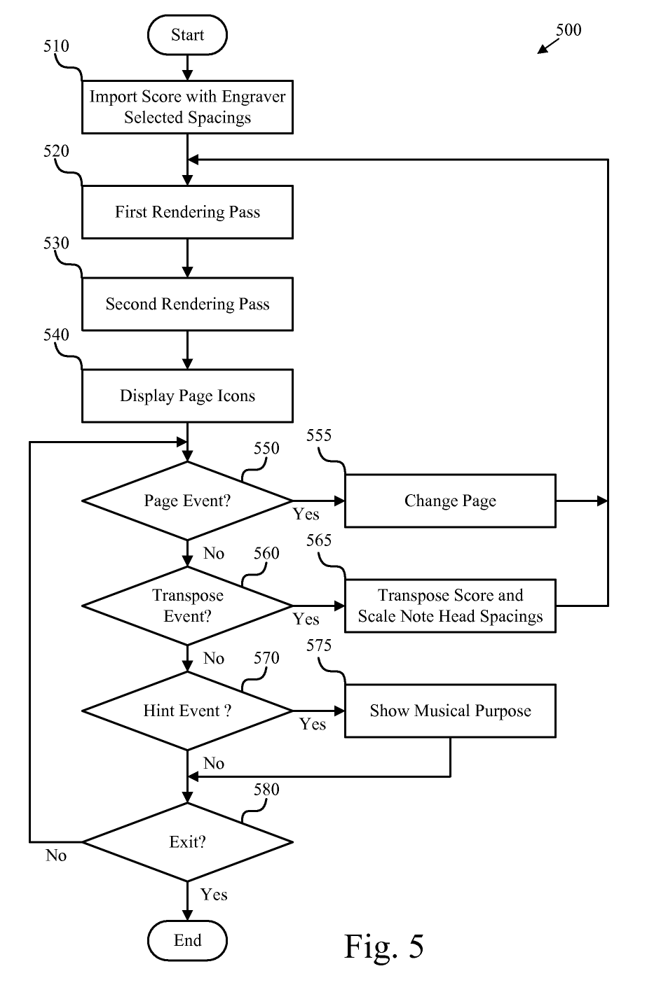

FIG. 5 is a flow chart diagram depicting certain aspects of one embodiment of a visual rendering method 500 of the present invention. The depicted visual rendering method 500 includes importing 510 a score, conducting 520 a first rendering pass, conducting 530 a second rendering pass, displaying 540 one or more page icons, testing 550 for a page event, changing 555 to a different page, testing 560 for a transpose event, transposing 565 the score, testing 570 for a hint event, showing 575 the musical purpose of an annotation or muscial element, and testing 580 for an exit event. The visual rendering method 500 provides a high quality representation of sheet music within a browser window or the like.

Importing 510 a score may include importing a score formatted by a professional engraver and preserving the typograpical spacing associated therewith. Preserving the typographical spacing increases quality in that professional engravers currently provide better typesetting than automatically generated typesetting by a computer or the like. Subsequently, conducting 520 a first rendering pass includes rendering note heads and other elements not affected by rendering context. Conducting 530 a second rendering pass to render note beams, note stems, cressendo's and the like, facilitates the inclusion of contextual information in the rendering process.

Once the current page of music is visually rendered, the method proceeds by displaying 540 one or more page icons. In one embodiment, multiple page icons are displayed in the bottom margin of the page and facilitate moving to a particular page of interest. Subsequently, the depicted method continues by testing 550 for a page event and changing 555 to a different page in response to the page event in the manner previously described.

The visual rendering method 500 may also include testing 560 for a transpose event and transposing 565 the score in response to such an event. In one embodiment, transposing 565 the score requires scaling the note head spacings in each system to account for a different key signature. Changing 555 to a different page and transposing 565 the score may require looping to the first rendering pass 520 and redrawing the current page (or drawing the selected page) to reflect the user requested changes.

Testing 570 for a hint event may include testing the position of the mouse to ascertain if it is proximate to a particular annotation or musical element, testing the screen coordinates associated with a mouse click, or some other operation to determine if a hint event has occurred. If a hint event has occurred the method proceeds by showing 575 the musical purpose of the particular annotation or musical element. Subsequently, the depicted method proceeds by testing 580 for an exit event and looping to the page event test 550 to continue responding to user generated events.

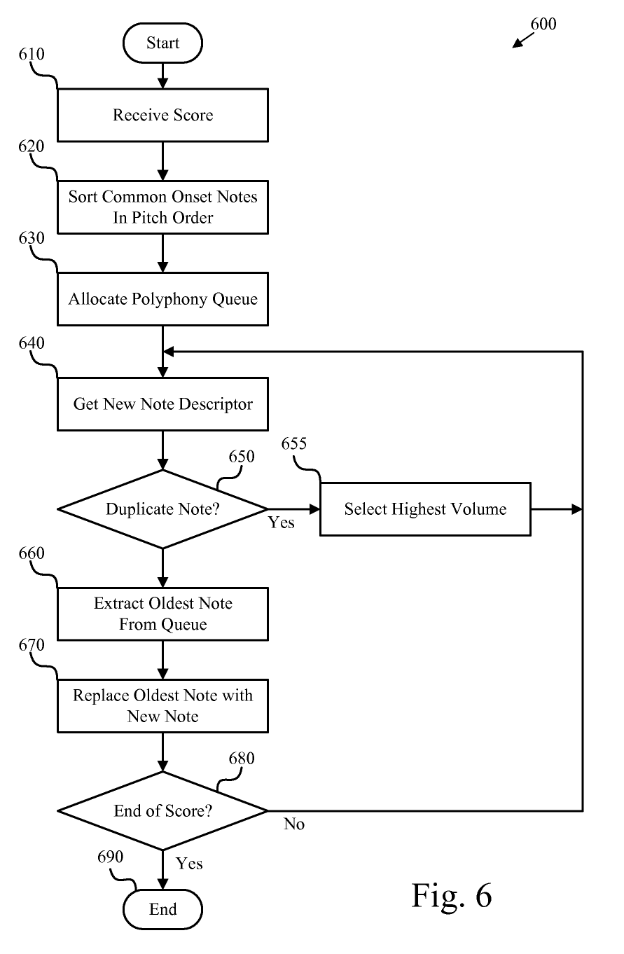

FIG. 6 is a flow chart diagram depicting certain aspects of one embodiment of a sonic rendering method 600 of the present invention. The depicted sonic rendering method 600 includes receiving 610 a score, sorting 620 notes in pitch order, allocating 630 a polyphony queue, getting 640 a new note descriptor, testing 650 for a duplicate note, selecting 655 a highest volume, extracting 660 an oldest note from the polyphony queue, replacing 670 the oldest note, and testing 680 for an end of score condition. For purposes of simplicity of presentation, certain aspects of the method such as the precise timing of operations are omitted and assumed to be addressable by one of skill in the art. The sonic rendering method 600 provides a high quality representation of sheet music within a browser window or similar environment with limited polyphony.

Receiving 610 a score may include downloading a score from a server. In one embodiment, the score is a serialized script object that has been compiled to a binary file for compactness and loading speed. The score may include a plurality of tracks corresponding to different instruments. In one embodiment, receiving 610 the score includes converting the score to an internal data format comprising blocks or segments that contain all notes (and annotations) having a common onset time. Such a process may occur at compile time (in response to a first user request) on the server.

Sorting 620 notes in pitch order only occurs on those notes that have a common onset time. Consequently, in certain emboidments sorting may be limited to notes within the same block. Sorting 620 notes in pitch order effectively increases the priority of the more perceptible higher pitched notes in that earlier notes will be dropped when the polyphony of the system is limited. In the depicted embodiment, the score is pre-sorted to reduce processing during real-time rendering. In another embodiment, sorting occurs concurrent with rendering.

In some embodiments, music is synthesized in real-time via audio mixing commands provided by a browser scripting environment and the polyphony of the rendering system is limited to the number of concurrently available audio channels. Allocating 630 a polyphony queue includes determining the polyphony of the system and allocating a queue whose length is equivalent to the number of concurrent notes supported by the environment. In one embodiment, the queue is a circular queue.

Getting 640 a new note descriptor includes retrieving the information necessary to render the note such as onset time, instrument or voice, volume, and duration. Testing 650 for a duplicate note includes testing for notes having a common onset time and instrument. If one or more duplicates are located the method proceeds by selecting 655 a highest volume from the duplicates and representing the duplicate notes as a single note of the selected volume. As a result, notes that are less perceptible are dropped from rendering.

Extracting 660 an oldest note from the polyphony queue need only occur when the polyphony queue is full. In some embodiments, references to notes are stored in the polyphony queue rather than actual notes or data structures representing notes. Extracting 660 may include waiting for an appropriate time (close to the new note onset time) and turning off the referenced note or verifying that the note has already expired.

Subsequently, the method proceeds by replacing 670 the oldest note in the polyphony queue with a reference to the new note or note descriptor. In one embodiment, the polyphony queue is a circular queue and a queue index indicates the location from which the oldest note is extracted and the new note is placed. In conjunction with replacing 670 the oldest note in the polyphony queue, the method may wait for the proper onset time and turn on the note (in the channel corresponding to the current queue index for example) and advance the queue index. Subsequently, the method proceeds by testing 680 for an end of score condition and looping to the get note descriptor operation 640. If an end of score condition has occurred the method ends 690.

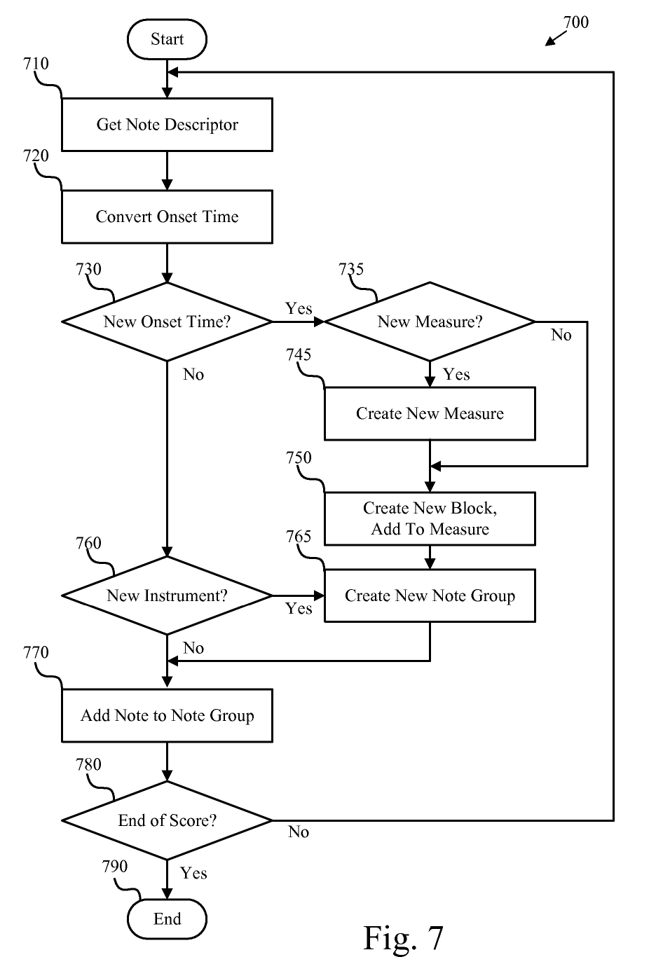

FIG. 7 is a flow chart diagram depicting certain operations 700 of one embodiment of a score conversion method of the present invention. The operations 700 include getting 710 a note descriptor, converting 720 the onset time of the note, testing 730 for a new onset time, testing 735 for a new measure, creating 745 a new measure, creating 750 a new block and adding it to the measure, testing 760 for a new instrument, creating 765 a new note group, adding 770 the note to a note group, and testing 780 for an end of score condition. The depicted operations facilitate converting a track-ordered score to a block oriented data format suitable for visual and sonic rendering within a browser window. See FIG. 11 and the associated description for more information on one embodiment of a block oriented format.

Getting 710 a note descriptor may include accessing a data record describing the note. In one embodiment, the descriptor is an XML data structure that includes a field specifying an onset time. Converting 720 the onset time of the note may include converting the onset time to global units suitable for use with all tracks of the score. In one embodiment, the global units are the coarsest unit of time that provides sufficient resolution for all tracks.

Testing 730 for a new onset time ascertains whether the onset time has been previously encountered. If the onset time is new, the method proceeds by testing 735 for a new measure. Testing for a new measure may include comparing the onset time to specific measure indicators in the score, or setting a flag in response to encountering a measure indicator. If the note is part of a new measure, the method proceeds by creating 745 a new measure data structure and creating 750 a new block (i.e. segment). In one embodiment, a reference to the new block is placed within the measure data structure.

Returning to test 730, if the onset time is not new, the method proceeds by testing 760 for a new instrument. In one embodiment, the instrument is associated with each track and the score is track ordered. In such an embodiment, assuming that the new instrument test is true may provide reasonable results. If the instrument is new, or a new block has been created in conjunction with creating a new measure, the method proceeds by creating 765 a new note group.

The score conversion method proceeds by adding 770 the note to the proper note group. The use of note groups is convenient in that notes on a particular staff (and therefore a particular instrument) may be processed as a group. For example, all the notes within a note group may share a common stem and other attributes such as onset time.

Subsequent to adding a note to a note group the method proceeds by testing 780 for an end of score condition. If the end of score condition has not occurred, the method loops to the get note descriptor operation 710. If the end of score condition has occurred, the method ends 790.

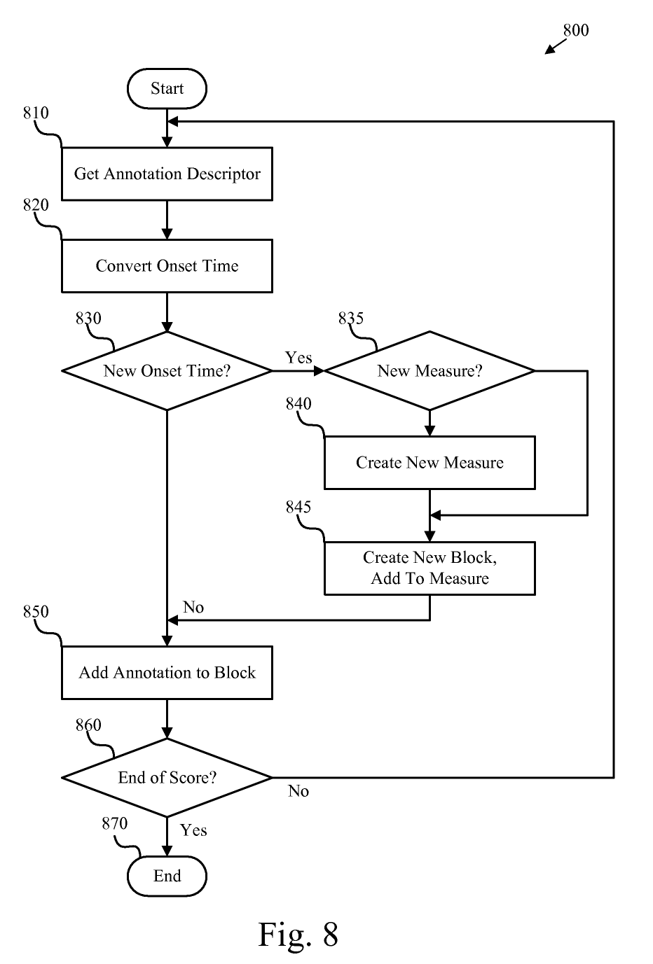

FIG. 8 is a flow chart diagram depicting additional operations 800 of one embodiment of a score conversion method of the present invention. The depicted operations include getting 810 an annotation descriptor, converting 820 the onset time of the annotation, testing 830 for a new onset time, testing 835 for a new measure, creating 840 a new measure, creating 845 a new block and adding it to the measure, adding 850 the annotation to a block, and testing 860 for an end of score condition. In one embodiment, the note related operations depicted in FIG. 7 and the annotation related operations depicted in FIG. 8 are integrated into a single method for converting a score to a block oriented format.

Getting 810 an annotation descriptor may include accessing a data record describing the annotation. In one embodiment, the descriptor is an XML data structure that includes a field specifying an onset time. Similar to operation 720, converting 820 the onset time of the note may include converting the onset time to global units.

Testing 830 for a new onset time determines whether a previously created block with the same onset time exists. If the onset time is new, the method proceeds by testing 835 for a new measure. If a new measure is required, the method proceeds by creating 840 a new measure, creating 845 a new block and adding it to the measure, and adding 850 the annotation to (newly created) block. Alternately, the method may proceed directly from test 830 to operation 850 if a block with the correct onset time already exists. The method subsequently proceed by testing 860 for an end of score condition and looping to operation 810 if more annotations remain in the score. Otherwise, the method ends 870.

The operations depicted in FIGS. 7 and 8 and described above convert a track ordered score to a block oriented data format suitable for visual and sonic rendering within a browser window. Beneficially, any formatting provided by an engraver or the like may be preserved to provide a publication-quality rendering of sheet music within a browser window.

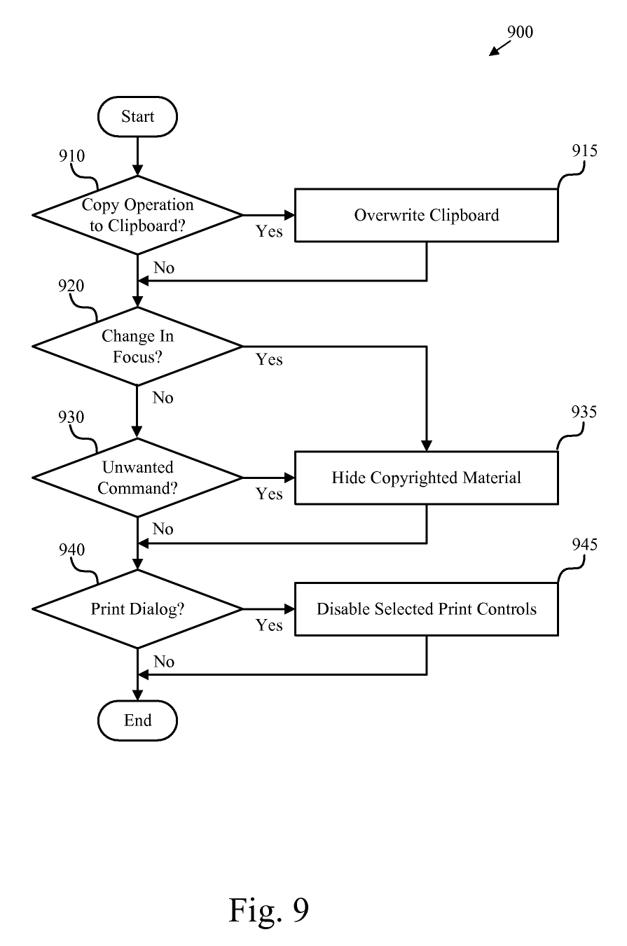

FIG. 9 is a flow chart diagram depicting one embodiment of a copy management method 900 of the present invention. The depicted copyright management method 900 includes testing 910 for a clipboard copy operation, overwriting 915 the clipboard, testing 920 for a change in focus and testing 930 for an unwanted command, hiding 935 copyrighted material, testing 940 for an active print dialog, and disabling 945 selected print controls. The copy management method facilitates restricting a user from printing or copying unauthorized copies.

Testing 910 for a clipboard copy operation may include testing if the user has asserted a combination of keys or similar stimulus that invokes a copy operation of copyrighted material. In one embodiment, testing 910 includes searching for a ‘print screen’ keystroke combination in a keyboard buffer. If a copy operation has been invoked the method proceeds by overwriting 915 the clipboard to effectively clear the copyrighted material from the clipboard.

Subsequently, the depicted method proceeds by testing 920 for a change in focus and/or testing 930 for an unwanted command. If a change in focus away from a window containing copyrighted material has occurred or an unwanted command has been invoked such as a print or copy command the method proceeds by hiding 935 the copyrighted material. In one embodiment, an error dialog replaces the copyrighted material and informs the user that they are not authorized to print or copy the copyrighted material. In another embodiment, the copyrighted material is cleared or overwritten to deny access and a separate error dialog is presented to the user.

The method continues by testing 940 for an active print dialog and disabling 945 selected print controls if the print dialog is active. Disabling selected print controls enables the present invention to restrict printing to a single copy. For example, in one embodiment, a control specifying the number of copies is set to one and made invisible.

The described copy management method 900 enables the present invention to restrict copying and printing of copyrighted material such as sheet music by overriding standard options provided by an operating system, browser scripting system, or the like.

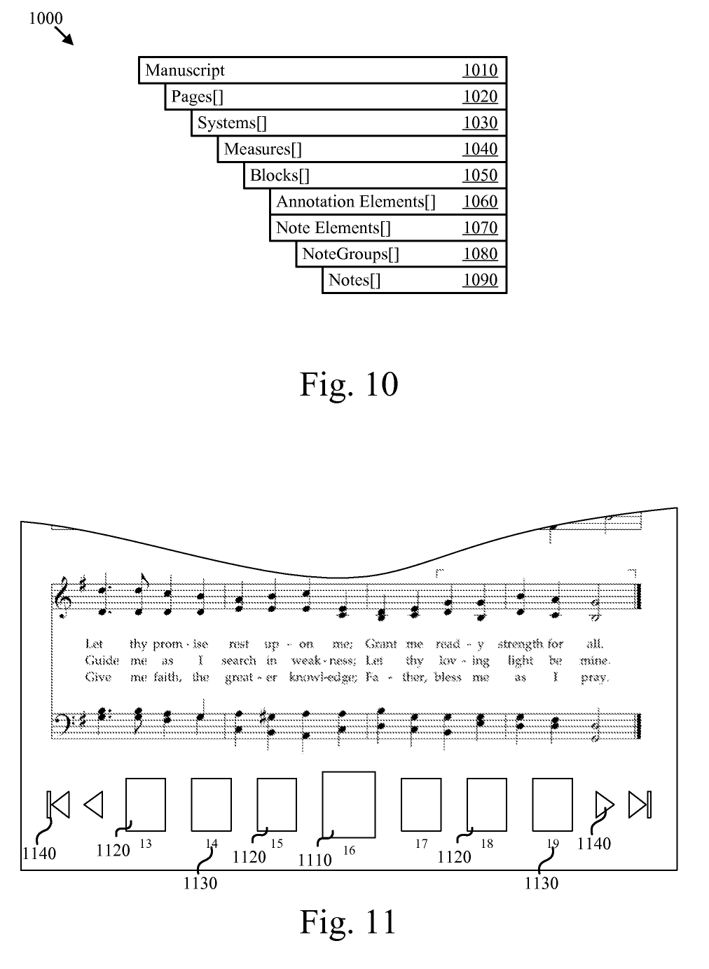

FIG. 10 is a text diagram depicting one embodiment of an internal data format 1000 of the present invention. The internal data format 1000 describes the elements within a manuscript 1010, including pages 1020, systems 1030, measures 1040, blocks 1050, annotation elements 1060, note elements 1070, notegroups 1080, and notes 1090. The internal data format 1000 facilitate efficient and effective rendering of music within a restrictive environment such as a browser window scripting environment.

A manuscript 1010 comprises one or more pages 1020 corresponding to sheets of music. Each page may contain or reference one or more systems 1030 corresponding to a ‘line’ of music comprising one or more staffs spanning from left to right across a sheet of music. Each system may contain or reference one or more measures 1040 which in turn may contain or reference one or more blocks 1050.

The present invention uses blocks (i.e. segments) as convenient units of rendering. All musical elements are placed or referenced within a block including annotation elements 1060, and note elements 1070. Typically, each element in the block shares a common onset time. However, to facilitate proper visual rendering some annotation elements such as slurs may be reference in the block in which they commence and in the block in which they end. Such elements may be present in both blocks and linked together (for example via a pointer or handle) to enable access from either block.

The note elements include notegroups 1080 that share a common instrument and staff, as well as certain music progression elements such as ‘move forward’ or ‘move backward’. The progression elements control the playback or flow of music at particular location such as at repeats and codas. Each notegroup may contain or reference one or more notes 1090. In one embodiment, rests are considered notes 1090 with a null pitch.

FIG. 11 is a partial front view illustration of a page display interface 1100 of the present invention. The depicted page display interface 1100 includes a current page icon 1110, adjacent page icons 1120, page indicators 1130, and scrolling controls 1140. The adjacent page icons 1120 enable a user to move to particular page indicated by the page indicators 1130. The scrolling controls 1140 enable a user to scroll a certain number of pages to the right or left (such as 5) or move to the end or start of the score.

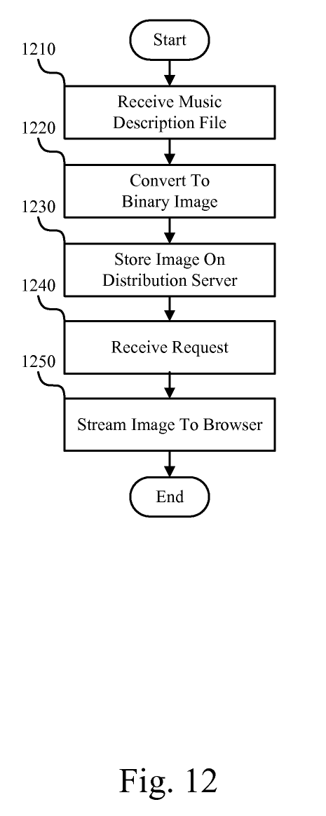

FIG. 12 is a flow chart diagram depicting one embodiment of a music publication method 1200 of the present invention. As depicted, the music publication method 1200 includes receiving 1210 a music description file from a publisher or the like, converting 1220 the music description file to a binary image suitable for use in a browser scripting environment, storing 1230 the binary data structure on a distribution server, receiving 1240 a request for the music, and streaming 1240 the binary image to a browser executing on a client. The music publication method 1200 provides an efficient mechanism for distributing music and may leverage the internal runtime structure of atomic music segments to compress the music and reduce the load time and rendering delays on the browser.

Receiving 1210 a music description file from a publisher may include receiving a text-based description such as music XML. The description file may be organized as a sequence of (horizontal) tracks. Converting 1220 the music description file may restructure the music to binary vertically segments of music suitable for visual and sonic rendering in a browser scripting environment.

Storing 1230 the binary data structure on a distribution server enables users to access the music. In one embodiment, the distribution server has searchable database associated therewith. Users may search the database looking for music with particular characteristics and generate a request to visually and/or sonically review the music.

In response, the depicted method may continue by receiving 1240 the request to review the music, and streaming 1250 the binary image to a browser executing on the users client. Subsequently, the user may decide to purchase the music and a financial transaction to purchase the music may occur between the user and distribution server.

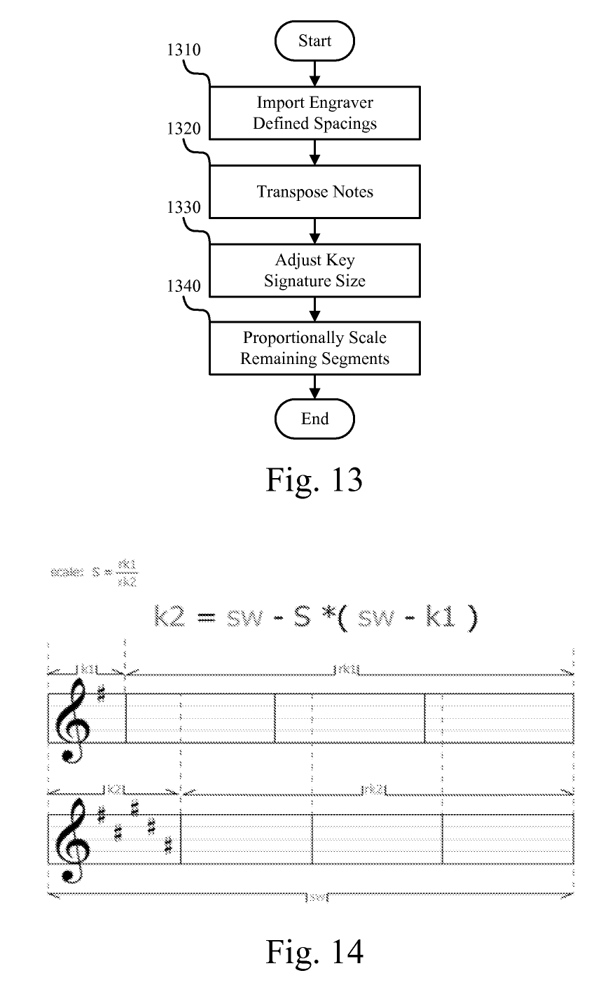

FIG. 13 is a flow chart diagram depicting one embodiment of a segment spacing method 1300 of the present invention. As depicted, the segment spacing method 1300 includes importing 1310 engraver defined spacings for a score, transposing 1320 the notes of the score, adjusting 1330 the size of the key signature segment, and proportionally scaling 1340 the remaining segments on a system. Proportionally scaling the remaining segments maintains the relative spacing provided by an engraver while supporting transposition and providing a highly interactive environment for a user. In one embodiment, the size of the notes remains constant while the size of the segments containing the notes is proportionally scaled.

FIG. 14 is an illustration depicting one embodiment of a segment spacing algorithm of the present invention. The depicted segment spacing algorithm is one example of a mathematical formula that enables execution of the segment spacing method 1300 depicted in FIG. 13. The depicted segment spacing algorithm scales the non-key signature space (rk1 to rk2) within a system to compensate for the change in key signature space (k1 to k2) while placing any rounding errors from scaling (by S) within the new key signature segment k2. Placing the rounding errors in the key

The present invention provides browser-based means and methods for high-quality rendering of sheet music. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for importing music, the method comprising:
receiving a plurality of music tracks, each music track comprising a plurality of note descriptors corresponding to a particular instrument, each note descriptor comprising a note onset time; and
creating a note block and a note group in response to a newly encountered onset time.

2. The method of claim 1, further comprising adding a note to the note group in response to another note within the music track having the newly encountered onset time.

3. The method of claim 1, further comprising creating a different note group and adding the different note group to the note block in response to a note descriptor within another music track having the newly encountered onset time.

4. The method of claim 1, further comprising adding the note block to a measure.

5. The method of claim 1, further comprising converting the onset time to a global time.

6. The method of claim 1, further comprising linking musical elements that span multiple blocks.

7. A method for rendering music, the method comprising:
importing an engraven score;
rendering note heads for each note in a measure during a first rendering pass; and
rendering note beams and stems during a second rendering pass.

8. The method of claim 7, further comprising adjusting note head spacing within a system in response to a transposition request.

9. The method of claim 8, further comprising re-performing the second rendering pass.

10. A method for rendering music, the method comprising:
allocating a polyphony queue having a length corresponding to an available channel count;
receiving a descriptor describing a new note;
extracting a reference to an oldest active note from the polyphony queue, the oldest active note associated with a channel; and
replacing the oldest active note within the channel with the new note.

11. The method of claim 10, further comprising providing a reference to the new note to the polyphony queue.

12. The method of claim 10, further comprising filtering duplicated notes to provide unduplicated notes.

13. The method of claim 12, further comprising selecting a highest volume for duplicated notes.

14. The method of claim 10, further comprising dropping lower pitched notes in response to excessive note onsets.

15. The method of claim 10, further comprising sorting the notes in pitch order.

16. A method for rendering music within a browser window, the method comprising:
displaying a currently selected page of music within a browser window from a score comprising a plurality of pages; and
displaying at least one page icon corresponding to other pages of music within white space of the currently selected page of music, each page icon comprising a page number corresponding to a particular page within the score.

17. The method of claim 16, further comprising changing the currently selected page to a particular page within the score in response to a user event indicating selection of the particular page.

18. A method for displaying music, the method comprising:
displaying a page of music comprising notes and annotations; and
displaying a hint educating a user on the musical purpose of a particular annotation in response to a user event corresponding to the particular annotation.

19. The method of claim 18, wherein the user event is a ‘mouse over’ event.

20. The method of claim 18, wherein the user event is a ‘mouse click’ event.

21. A method for preventing unauthorized copying of copyrighted material, the method comprising:
detecting invocation of a print dialog; and
disabling selected print controls in the print dialog to prevent unauthorized printing of copyrighted material.

22. A method for preventing unauthorized copying of copyrighted material, the method comprising:
detecting a copy operation to a system clipboard; and
overwriting the system clipboard to clear the system clipboard of copyrighted material.

23. The method of claim 22, further comprising clearing a window displaying copyrighted material in response to a change in user focus.

24. A method for preventing unauthorized copying of copyrighted material, the method comprising:
detecting an unwanted command request from a user; and
clearing a window displaying copyrighted material.

25. A data format for rendering music within a browser window, the data format comprising:
a sequence of atomic music segments, each atomic music segment comprising at least one music element; and
each music element of the at least one music element having a substantially common onset time.

26. A method for distributing sheet music, the method comprising:
receiving a music description file from a publisher;
converting the music description file to a binary image suitable for use in a browser scripting environment;
storing the binary data structure on a server; and
streaming the binary image to a browser executing on a client.
